(19) United States
(12) Patent Application Publication
(10) Pub. No.: US 2013/0251880 A1
(43) Pub. Date: Sep. 26, 2013

(54) PROCESS FOR PRODUCING A SWEETENED CHEESE PRODUCT HAVING A DRY EXTRACT OF BETWEEN 30% AND 60% AND COMPRISING AT LEAST ONE CEREAL

(71) Applicant: Christophe Cheneval-Pallud, Perrigny (FR)

(72) Inventor: Christophe Cheneval-Pallud, Perrigny (FR)

(73) Assignee: FROMAGERIES BEL, Paris (FR)

(21) Appl. No.: 13/991,391

(22) PCT Filed: Nov. 30, 2011
(86) PCT No.: PCT/EP11/71357

§ 371 Date: Jun. 3, 2013

(30) Foreign Application Priority Data
Dec. 3, 2010 (FR) 10 60071

(51) Int. Cl. A23C 19/097

(52) U.S. Cl. CPC A23C 19/0973
USPC 426/582; 426/392

(57) ABSTRACT

The invention concerns a method for producing a sweet dairy product having a dry extract between 30 and 60%, consisting of a melted cheese base and at least one cereal, as well as a sweet dairy product obtainable by this method. The sweet dairy product is characterised by a long shelf life, i.e., an unrefrigerated shelf life of up to 4 months.

The invention concerns a method for producing a sweetened dairy product having a dry extract between 30 and 60%, consisting of a melted cheese base and at least one cereal, as well as a sweetened dairy product obtainable by this method. The sweetened dairy product is characterised by a long shelf life, i.e., an unrefrigerated shelf life of up to 4 months.

“Unrefrigerated” refers to storage at an ambient temperature between 10 and 30° C.

Sweet dairy products such as fermented sweetened products such as yoghurts and fresh dairy desserts are known from the prior art; they are widely used in commerce. These are essentially milk-based foods designed to provide the basic nutritional qualities of the milk in easily assimilated forms, and having a wide variety of textures, flavours, or other organoleptic qualities. This family of dairy desserts includes jellied desserts, cream desserts, compacted desserts, and aromatised flavoured, jellied milks. They are produced from a mixture of pasteurised milk with homogenised fat content, thickeners, and/or stabilisers (starch and derivatives). emulsifiers. and gelling agents (gums, carrageenans), sugar, flavours, and, in some cases, dyes. The mixture is homogenised and heat treated (at a temperature of approximately 60° C.), then sterilised (at a temperature of approximately 135° (for 2-4 s) to ensure the preservation of the product; it is then cooled to approximately 75 packaged at that temperature, and stored between 0 and 6° C. for marketing. A method for producing these sweetened dairy products is described, e.g., in the work of F M Luquet: <<Lait et produits laitiers>>tome 2—Editions Lavoisier 1985, pp. 35-43. These products must be kept at a temperature of 0-6° C. and consumed within a very short time (shelf life of less than 1 month). These products generally have a dry extract of less than 30%.

Dairy desserts having a longer shelf life are available on the market, but these products have undergone a sterilisation treatment by autoclave (appertization), requiring specific equipments and autoclave-resistant packaging (metal box, glass pots, bags of plastic suited for autoclave treatment). Contrary to the technology for producing melted cheeses, in which the mixture is heat treated before being hot-packaged, appertization consists of packaging the product in a hermetically sealed container and sterilising the whole thing in an autoclave according to precise sterilisation scales that are suited for the product to be sterilised. It would be worthwhile to propose a less constraining method than appertization, which would allow for sweet dairy products with longer shelf life to be obtained, in particular products capable of being stored without refrigeration for prolonged periods. These sweetened dairy products having a carbohydrate content between 20 and 25 g/100 g, would be particularly interesting, in particular for the populations of countries having few or no distribution chains that ensure cold storage.

Furthermore, there are dairy products on the market such as melted cheeses for various uses: Spreading, slicing, crunching, cooking, dipping, and in various formats (triangular, parallelepiped, prismatic, cylindrical pieces: or slices, packets, jars. cups, etc.). These products may be natural and/or flavoured, and may contain added ingredients (nuts, hazelnuts, formed elements, fruits, sweet flavourings, etc.).

Traditionally, “melted cheese” refers to products from melting, by heat treatment between 80 and 140° C., of cheeses and/or other dairy products (whole or skim milk powder), milk protein concentrates, milk and/or vegetable fats, etc.

Because of the choice of raw materials used in the formulation and the production technology, this category of cheeses has numerous advantages, in particular due to its possibilities for storage (up to one year), the creation of an infinite range of tastes and textures, and the good nutritional value of the products, which can be adapted to specific needs.

In this application, “melted cheese” refers to the melted product or base obtained by heat treatment at a temperature between 80 and 145° C., of a mixture of at least one proteinaceous material originating from milk and at least one fatty material of animal and/or vegetable origin, in the presence of melting salts and/or other emulsifiers and/or texturing agents. Accordingly, the term “melted base” will be used below.

Although melted cheeses have a nutritional value equivalent to that of other cheeses (fresh cheeses, cooked paste cheeses, pressed paste cheeses, soft cheeses, and stretched cheeses), they nonetheless have certain disadvantages, in particular their cost, due to the cost of the raw materials included in their composition.

Additionally, despite their good nutritional value, cheeses are essentially consumed in the countries of origin (Europe, Russia, North and South America). However, it would be worthwhile for the populations of Asia and Africa to be able to consume them; however, because these countries have to import them, they would be relatively expensive, in particular for a segment of the populations of these countries with low purchasing power. Additionally, these populations do not appreciate the specific taste of cheeses, which may lead to rejection by them. Additionally, cheeses have a lack of complex carbohydrates or polysaccharides, carbohydrates recommended by nutritionists as part of a balanced diet, in which they should constitute 50-55% of the total calorie intake.

The main polysaccharide is starch, a reserve in vegetables, in particular cereals. For example, it constitutes up to 90% of the dry extract of rice.

The main cereals cultivated in the world are wheat, rice, maize, barley, sorghum, and millet. They are cultivated on all continents, and constitute a human staple food. They are adapted to the climate in which they are cultivated: Wheat for temperate climates, rice for hot and humid climates, sorghum for dry climates.

They are consumed in the form of cooked grains (e.g., rice, wheat, maize), or used as flour, essentially transformed into various foods: Bread from various flours, pastes, etc.

Thus, rice is the third most commonly produced cereal in the world after wheat and maize, and the main cereal consumed, and the nutritional basis for more than half of the world's population, providing 50% of all calorie intake. It is cultivated on all continents, but the production and commercial exchanges are 90% concentrated in Asia.

These cereals are rich in polysaccharides in the form of starch, which consists of two polymers: Amylose and amlyopectin. In plants that are industrially cultivated and exploited, the proportions are 5-50% amylose and 50-95% amylopectin. These rates are variable depending on the species, and within a species depending on varieties.

Cereal products have always played a major role in child and adult nutrition, both due to their caloric content, and, in certain populations in which they constitute the main food due to their protein content (between 7% for rice and 12% for wheat or sorghum). Cereal proteins have an interesting essential amino acid content, although it is less than that of animal proteins due to their lack of sulphurous amino acids such as lysine, resulting in the presence on the market of foods having a complimentary animal/plant protein content in order to provide the necessary amount of all amino acids. To this end, a combination of cereals and cheese would be particularly worthwhile.

Furthermore, cereals contain B vitamins (BH1 or thiamine, B2 or riboflavin, B6 or pyroxidine, PP or niacin), but lack vitamins A, C, and D. They are also characterised by a high potassium (300 mg/100 g), magnesium (100-180 mg/100 g), and phosphorus content (300-400 mg/100 g), but a low calcium content (20-60 g/100 g).

TABLE
Composition of Cereals:

| | Moisture | Proteins | Lipids | Carbohydrates | Fibres (g) | | | Minerals | Energy | |
|---|---|---|---|---|---|---|---|---|---|---|
| Food | (%) | (g Nx 6.25) | (g) | (g) | Food | insoluble | lignin | (ash) (g) | (kJ) | Kcal |
| Brown rice | 14 | 7.3 | 2.2 | 71.1 | 4.0 | (2.7) | (0.1) | 1.4 | 1610 | 384 |
| Wheat | 14 | 10.6 | 1.9 | 61.6 | 10.5 | (7.8) | (0.6) | 1.4 | 1570 | 375 |
| Maize | 14 | 9.8 | 4.9 | 60.9 | 9.0 | (6.8) | (0) | 1.4 | 1660 | 396 |
| Millet | 14 | 11.5 | 4.7 | 64.6 | 37 | (2.3) | (0) | 1.5 | 1650 | 395 |
| Sorghum | 14 | 8.3 | 3.9 | 57.4 | 13.8 | (12.4) | (3.0) | 2.6 | 1610 | 384 |
| Rye | 14 | 8.7 | 1.5 | 60.9 | 13.1 | (8.4) | (1.4) | 1.8 | 1570 | 375 |
| Barley | 14 | 9.3 | 5.9 | 63.0 | 5.5 | (39) | (0) | 2.3 | 1640 | 392 |

From the foregoing, the value of proposing, in particular for the populations of Asia and Africa, a composite product consisting of a combination of cheese and cereals with a good shelf life (in particular unrefrigerated), even under hot climatic conditions, that is practical to consume and suited to their taste, can be seen. For the latter aspect, a sweet product must be preferred.

Products combining cheese, including melted cheese, and cereals (essentially bread) are known from the art; the combination may be direct or indirect. These combinations have mostly been provided in milk-producing countries in which the predominant cereal is wheat; this results in combinations primarily of bread or biscuit and cheeses. Thus, direct combinations include sandwiches (which have a short shelf life, generally less than 1 week when refrigerated) and biscuits, on which the cheese is provided in the form of powder.

In the context of a long shelf life at the unfrozen state, it is very difficult to combine these two product types because of the moisture transfer between the moist product (cheese) and the dry product (bread) in the absence of an intermediate protective layer to prevent this transfer. Indeed, the cereal product looses its flavour and texture integrity. The applicant has filed a patent application (FR 2 769 471) concerning a direct combination of melted cheese and a cereal product, but this combination required, as the cereal product the exclusive use of sponge cake- or sandwich loaf-type cereal products, as these two cereal products may be consumed in moist form without losing their integrity. However, the combination was reduced to one type of cereal product, and the finished product was expensive due to the price of the raw materials. On the other hand, international patent applications WO 2007/04998 and WO 2008/054232 describe the production of a cheese product involving the use of a mealy ingredient in particular one that is cereal- and tuber-based, more particularly rice, up to 10% in formulas for melted cheeses. The ingredient is included in the form native starch and/or flour. Application WO 2007/04998 describes the mealy ingredient of rice has an amylopectin content of under 90%. The objective is to use this starch or flour to partially replace the proteinaceous portion of these formulas (casein) in order to obtain products that are sufficiently firm to be sliced, grated, crunched, and, for slices that are easily detached from the packaging (plastic film). Rice starch and/or flour are used for technological purposes and not to provide the consumer with a product with high nutritional value. Furthermore, these applications do not mention the use in the formulation of cooked cereals in hydrated form, mixed with a melted cheese base. Lastly, the maximum heat treatment temperatures are limited to 100° C. for the method described by application WO 2008/054232 and 85° C. for the method described by application WO 2007/049981. Products arising from the methods described in these 2 patent applications have cheesy flavours that are predominantly salty. Patent application PP 1 135 028 describes the use of hydrated rice in the production of stretched curd cheeses such as mozzarella. To this end, the rice is heat treated in the presence of water under high shearing in order to obtain a semiliquid mixture to be included in the stretched cheese curd by means of pulverisation of the water/rice mixture until its inclusion in the cheese. The cheese is then cooled and moulded, The objective is to obtain a stretched curd cheese with lower fact content, with the rice replacing the fatty matter.

Patent application US 2006/0172054 describes the production of low-fat stretched curd cheeses by another method: The incorporation of rice flour in the curd and treatment of the mixture in accordance with the traditional stretched curd cheese production steps (heat treatment (68-73° C., stretching). The rice flour is used at a rate of 0.5-10%, preferably 2-6%. as a fat substitute, and results in a homogeneous, firm product.

Applications EP 1 135 028 and US 2006/0172054 thus describe the use of rice flour or hydrated rice as a substitute for fatty matter exclusively with stretched curd cheeses at quantities of less than 10%. Furthermore, according to application US2006/0172054, amounts greater than 6% do not allow for complete inclusion of the water/rice mixture in the cheese.

The applicant seeks to propose cheese products with good unrefrigerated storage properties and sweet flavours and scents. To this end, the applicant initially developed the following methods (percentages are by weight of the total weight of the cheese product obtained):

a first method consisting of heat treatment at a temperature of 100-140° C. of a mixture of milk protein (5-40%), animal and/or vegetable fat (15-30%), emulsifiers (0.1-3%), sugar (5-15%), cereal in the form of flour or hydrated cereal (5-15%), packaging the mixture at 70-100° C., and cooling it,

a second method consisting of producing a melted base from milk proteins (5-40%), fat (15-30%), sugar (5-15%), and emulsifiers (0.1-3%), and including within this melted mass a cooked, hydrated cereal constituting up to 60% by weight of the total weight of the mixture, heat-treating the mixture at a temperature of 100-140° C. for 30 s-6 min, hot packaging the mixture, and cooling it.

The applicant found that the cheese products obtained had substantial bacteriological issues, resulting in inflation and poor storage properties of the product at room temperature. The presence of sugar in the mixture promotes the development of residual bacterial provided primarily by the non-sterile protein concentrates. In dealing with this problem, the applicant showed, unexpectedly, that treatment with high heat, combined with a carefully chosen pH and a specific juxtaposition of the steps of the production method allows for elimination of the bacteriological issues and improvement of the storage properties of the products.

The invention thus concerns a method for producing a sweet cheese product having a dry extract between 30 and 60%, consisting of a mixture of a sweet melted cheese base and at least one cereal, and the treatment of the mixture at a temperature between 80 and 145° C., preferably between 110 and 145° C., for 3s -6 min.

The invention further concerns a sweet cheese product obtained or obtainable by this method.

Method of Production

The invention concerns a method for producing a sweet cheese product having a dry extract between 30 and 60%, preferably between 35 and 50%, comprising a mixture of a sweet melted cheese base and at least one cereal, said process comprising the following steps:

a) heat treatment at a temperature between 80 and 145° C. (inclusive) for 3s -6 min, of a mixture comprising, by weight of the total weight of the mixture:
3-40%, preferably 5-40%, dairy protein;
10-30%, preferably 15-30%, fat;
5-15% sugar;
0.1-3% emulsifier and/or texturing agent;
0.1-0.5%, preferably more than 0.2-05%, acid;
water, and
3-15%, preferably 5-15%, of at least one cereal, expressed in dry weight of the cereal, the cereal being included in the mixture in the form of flour and/or cooked and hydrated form;

b) hot packaging of the heat-treated mixture at a temperature between 70 and 100° C.;

c) cooling to a temperature between 5 and 15° C.

According to a specific embodiment of the method, the cereal is included solely in the form of flour directly inserted into the formula of the melted cheese base. Preferably, the flour constitutes 5-10% by weight of the total weight of the mixture.

With this method, a product having a smoother, more homogeneous texture is obtained.

The invention further concerns a method for producing a sweet cheese product having a dry extract between 30 and 60%, comprising a mixture of a sweet melted cheese base and at least one cereal, comprising the following steps:

a) preparing a sweet melted cheese base by heat treatment at a temperature between 80 and 145° C. for 3s -6 min, of a mixture comprising, by weight of the total weight of the mixture:
3-40%, preferably 5-40%, dairy protein;
10-30%, preferably 15-30%, fat;
5-15% sugar;
0.1-3% emulsifier and/or texturing agent;
0.1-0.5%, preferably more than 0.2-05%, acid; and
water:

b) mixing the sweet melted cheese base with at least one cereal, the at least one cereal being included in the mixture in the form of flour and/or cooked and hydrated form and constituting up to 60% by weight (hydrated) of the total weight of the mixture with the melted cheese base;

c) heat treatment of the mixture from step b) at a temperature between 100 and 145° C., for 3s -6 min;

d) hot packaging of the mixture heat-treated in step c) at a temperature between 70 and 100° C.;

e) cooling to a temperature between 5 and 15° C.

According to one embodiment of this method, when the cereal is in cooked, hydrated form, the mixture may further comprise 3-15%, preferably 3-10%, still preferably 5-10%, by weight of the total weight of the mixture, of at least one cereal flour.

Additionally, the hydrated, cooked cereal included in the sweet melted cheese base in step b) will have been cooked for a period and at a temperature suited for the type of cereal used, typically in boiling water or steam at a temperature of 100-120° C. for 15-60 min, preferably 100° C. for 30-50 min, with a volume ratio of cereal to water suited for each cereal. For example, the rice may be cooked at a ratio of 1 volume of rice/2-4 volumes of water. By this operation, the volume of the rice is multiplied by 2-4, and the dry extract of the rice at the end of cooking is between 20 and 30%.

The advantage of the methods above is that they may allow the cereal grains to be found m the finished product, thus creating an original texture contrast.

The heat treatment of step a) of the methods of the invention will preferably occur at a temperature of 100-145° C., more preferably over 115° C., or 115-145° C., and even more preferably 140-145° C.

The milk protein is selected from the group of whole milk powder, skim milk powder, caseins, caseinates, milk protein concentrates, serum protein concentrates, fresh or ripened cheeses, curds, yoghurts, fermented milks, and a mixture of these dairy proteins.

All of these raw materials are well known to persons skilled in the art and widely available on the world market. Examples include the products marketed by Fonterra, Aria Foods. Their manufacturing technology is also described in Vignola C.: Science et Technologic du lait Ed Polytechalique de Montréal 2002.

“Sugars” refers to any natural product used for its sweetening effect. This term refers in particular to saccharose (beet or cane sugar), glucose (starch syrup), or fructose (fruit sugar).

The sugar is advantageously saccharose.

The sugar may also be substituted in part or in whole with sweeteners such as aspartame (E 951), saccharine and its salts (E 954), thaumatin (E 957), Lactitol (E 966), xylitol (E 967), stevia, etc. In this ease, the amount used will depend on the sweetening power of the sweetener, and range from 0-5%; the sweeteners may be used alone or in a mixture.

The fat is of animal or vegetable origin, or is a mixture of fats of vegetable and animal origin.

Examples of animal fats include milk fat, anhydrous milk fat, butter, and cream. Examples of vegetable fats include soy, sunflower, palm, palm kernel, copra, peanut, rapeseed oil, and any vegetable oil used in the production of food products and available on the market. The acid is an edible acid chosen, in particular, from lactic or citric acid, or products such as glucono-delta-lactone, which allows for progressive acidification.

The pH of the sweet cheese product obtained is advantageously between 5.0 and 5.6.

The emulsifiers/texturing agents are preferably melting salts well known to persons skilled in the art such as sodium or potassium polyphosphates or sodium or potassium citrates, but also other emulsifiers such as Datems (diacetyl tartric mono-diglyceride esters, SSL and CSL (sodium or calcium stearoyl lactylates)). They are used alone or in mixture, and included in the formula at a content of between 0.1 and 3%, preferably 0.5-2%.

Hydrocolloids such as carrageenans, guar, carob, xanthan gum, starch, agar-agar, and any other texturing agent well known to persons skilled in the art may be used.

The cereals are added either at the same time as the other ingredients in the melted cheese base before heat treatment, or incorporated into the hot melted cheese base. They are included either in dry form (flour) or in hydrated form following cooking in boiling water, depending on the method of the invention that one wishes to apply. Generally, the proportion of cooked hydrated cereal will not exceed 60% by weight of the total weight of the mixture with the sweet melted cheese base. Preferably, the proportion of cooked hydrated cereal will be between 15 and 50%, preferably 30 and 50%, of the total weight of the mixture with the sweet melted cheese base. The dry extract of the cooked hydrated cereal is generally between 20 and 35%, more particularly 22-28%.

In the methods of the invention, a mixture of cereals, or a mixture of at least one cereal with other plant sources such as legumes cultivated for their grains, etc. may be used, the latter at a quantity of less than 2% dry weight.

In the methods of the invention, fruits may also be used to partially replace the sugar: Thus, part of the 5-15% sugar is contributed by the fruits. Examples of the fruits used include bananas, prunes, black currants, guava, chestnuts, figs, and dates. In this embodiment, the proportion of fruits may be up to 20% by weight of the total weight of the mixture, preferably 2-20%, 3-20%, 4-20%, 5-20%, 6-20%, 7-20%, 8-20%, 9-20,%, 2-15%, 3-15%, 4-15%, 5-15%, 6-15%, 7-15%, 8-15%, 9-15,%, 2-10%, 3-10%, 4-10%. 5-10%, 6-10%, 7-10%, 8-10%, 9-10% of the mixture.

The cereals are chosen from amongst those available on the market and widely consumed worldwide such as wheat, barley, maize, and rice; the latter is preferably chosen for its universal consumption, its worldwide availability, and the low amylose content of certain varieties. More local cereals, such as quinoa (South America), millet or sorghum (Africa) may also be used. The cereals are used in their commercially available state. For example, rice is used in the form of milled rice, steamed or not (i.e., following hydrothermal steaming and shelling treatment (elimination of the woody envelope) or whole rice or cargo rice (preservation of the pericarp). Sticky varieties, which have a lower amylose content, are preferred. Furthermore, it is also preferable to use the cereals available on the local markets where the product will be marketed (rice in Asia, quinoa in South America, millet and sorghum in Africa, wheat in Europe, maize in North America, etc.).

The cereal, which, when not in the form of flour is preferably hydrated, is included in the melted cheese base at a proportion that is useful for obtaining the desired nutritional characteristics of the final product, i.e., a composition allowing for a contribution of nutrients that is close to the WHO recommendations (i.e., an intake of 12% of proteins, 33% of lipids, and 55% of carbohydrates). By way of an example, a formula providing 12% proteins, 32-33% lipids, and 55% carbohydrates will consist of a mixture of 60% cooked rice (dry rice content of 15%) and 40% of melted base.

Preferably, cereals will be chosen from amongst those with an amylose content of less than 20%, more particularly less than 10%. The smoother the desired texture, the lower the amylose content must be. A low amylose content ensures better preservation of firmness over time and low syneresis due to less starch retrogradation.

By varying the amylose/amylopectin ratio of the cereal(s) used and the time/temperature/shearing speed parameters of the production method, a wide range of products with variable consistencies and textures can be obtained.

In order to optimise the nutritional value of the final product, vitamins and minerals such as calcium, potassium, magnesium, zinc, iron, iodine, etc. in soluble or insoluble forms, or trace elements may be added to the mixture.

Preferably, in the mixture of step a) of the methods of the invention, which allows for the preparation of a melted cheese base, the water is in a sufficient quantity up to 100% (sufficient quantity for 100%), i.e., for example, the mixture does not contain any ingredients but dairy protein, fat, sugar, one or more of the emulsifiers and/or texturing agents, and, optionally, cereal flour and/or flour of a legume cultivated for its grains, and vitamins and/or minerals.

The melted cheese and hydrated cereal base is cooked at a temperature of at least 80° C., preferably greater than 110° C., for several minutes, up to 145° C. for several seconds, typically between 100-145° C. for 3 s-6 min, and preferably between 110 and 140° C. for 1-6 min. The heat treatment occurs with stirring (800-3000 rpm, preferably up to 1500 rpm) in classical equipment used in melted cheese technology, i.e., batch cooking equipment such as cutters (e.g., those marketed under the trademark Stephan®) or continuous heat treatment equipment such as a UHT steriliser, or kneader-type apparatus, mixers, kneader, mixer/cookers, co-kneader, extruders.

The mixture is then cooled to the packaging temperature of 70-100° C., preferably between 75 and 95° C., more preferably between 75 and 90° C.

In the methods of the invention, the hot-packaged product is preferably cooled to a temperature of 5-15° C.

It may be stored up to 4 months at room temperature, i.e. between 10 and 30 or up to 1 year with refrigeration between 4 and 10° C.

In preferred embodiments of the invention, a sweet melted cheese base is made from powdered protein concentrates (7.5%), 30% of a 50/50 mixture of dairy and vegetable fat, 10% sugar (saccharose, 1% sodium polyphosphates, preferably 0.5% sodium polyphosphates, 0.2% lactic or citric acid, and water sufficient for 100%. The melted cheese base is then mixed with rice in the form of milled and hydrated rice grains at proportions of 80% melted cheese, 20% milled and hydrated rice, by weight). The product obtained has a dry extract of 40%, a protein content of 6%, a lipid content of 14%, and a carbohydrate content of 18% (in dry weight).

Sweet Cheese Product

The invention further concerns a sweet cheese product obtained or obtainable by a method of the invention.

The sweet cheese product of the invention has a dry extract between 30 and 60%, preferably between 35 and 50%, and comprises, by weight, at least 85% melted cheese (in dry weight, as the cereal or cereal mixture is no more than 15% by dry weight).

Its composition is as follows (percentages are by weight of the total weight of the cheese product):
dairy protein: 3-40%, preferably 5-40%, more preferably 5-10%;
fat: 10-30%, preferably 15-30%;
emulsifier and/or texturing agent 0.1-3%;
cereal: 3-15%, preferably 5-15%;
sugar: 5-15%;
acid: 0.1-0.5%, preferably more than 0.2-0.5%;
water: Sufficient for 100%

Preferably, the cereal has an amylose content of less than 20%, more preferably less than or equal to 10%.

In a preferred embodiment, part of the 5-15% sugar is contributed by the fruits. Examples of the fruits used include bananas, prunes, black currants, guava, chestnuts, figs, and dates. In this embodiment, the proportion of fruits may be up to 20% by weight of the total weight of the mixture, preferably 2-20%, 3-20%, 4-20%, 5-20%, 6-20%, 7-20%, 8-20%, 9-20%, 2-15%, 3-15%, 4-15%, 5-15%, 6-15%, 7-15%, 8-15%, 9-15,%, 2-10%, 3-10%, 4-10%, 5-10%, 6-10%, 7-10%, 8-10%, 9-10% of the mixture.

This shows the value of these sweet dairy products in terms of the innumerable possibilities offered by the careful combination of dairy and cereal raw materials both from a nutritional standpoint and in terms of taste and texture.

The taste may be adjusted in a wide range adaptable as desired to the tastes of the populations for whom the food is intended, either by choosing raw materials, in particularly dairy, or by adding specific. predominantly sweet, flavourings (fruits, sugar, vanilla, etc.).

The final products obtained may have widely varied textures based on the desired use: Crunching, spreading, sucking, or slicing. Generally, the product will have a firmness between 20 and 200 g, preferably 20 and 150 g, measured by a Stevens device. To this end, a cylindrical probe having a diameter of 6.35 mm, a speed of 0.2 mints, and a depth of 7 mm is used for measuring. The measurement is carried out on a sample at 20° C. The result is the penetrometric peak (maximum value), which reflects the firmness of the product. For a product for spreading, this value is between 40 and 50 g, preferably between 50 and 80 g; for a product for crunching, it will be greater than 150.

The finished product may be packaged in different packaging: Jars, tray, flexible pouches, slices, portions, pods, bags, etc. In the same packaging, products with homogeneous flavour and texture may be included, or various layers of products having different tastes, textures, and colours.

An advantageous packaging consists of a flexible pouch of waterproof material representing a single consumption dose (less than 100 g, preferably less than 50 g) of the product to be consumed at any time. The advantage of a single dose is that it is practical and there is no risk of contamination following opening because it is consumed immediately and completely. The product may have a semi-liquid texture for sucking, or a firm texture for crunching.

Furthermore, because of the method used (heat treatment up to 145° C.) and the hot packaging (70° C. or more), optimal food safety and a shelf life greater than 3 months, up to 4 months, at a temperature between 10 and 30° C., or 1 year in refrigeration at a temperature between 4 and 10° C., is obtained due to the lack of microbiological flora altering the product.

Whether by the choice of raw materials and original ingredients, allowing for an infinite range of tastes and textures, or the production and packaging method chosen, the new product of the invention is in all senses a product that is adapted, adaptable, and processable for all consumers and cultures. It is suited for all means of consumption as it is not positioned within a precise framework, and can be adapted to any place and means of consumption: At home, at school, in catering, or in the street.

The sweet cheese product of the invention provides all of the macronutrients necessary for human nutrition, proteins, lipids, and carbohydrates at a ratio close to the recommended nutritional allowances of the WHO (World Health Organisation). The WHO recommended allowances for macronutrients are (in % of total calories):
Proteins: 12%
Lipids: 33%
Carbohydrates, including simple (10-15%) and complex carbohydrates: 55%.

The invention is also illustrated by the following examples, which do not limit its scope.

### EXAMPLES

### Example 1

Products are produced according to the 4 formulas presented in the table below:

| Raw materials | A | B | C | D |
|---|---|---|---|---|
| and additives | % | % | % | % |
| Butter | 19.1 | 23.2 | | |
| Vegetable fat | | | 15.7 | 22.4 |
| Rice | 5 | 8 | 10 | 12 |
| Acidic casein | | 2.54 | | |
| 0% milk powder | 6 | | 14.8 | |
| Milk protein | 3.3 | | | 11.0 |
| concentrate (70% | | | | |
| protein content) | | | | |
| Milk protein | | 2.7 | | |
| concentrate (80% | | | | |
| of dairy protein) | | | | |
| Sugar | 9 | 10 | 5 | |
| (commercial | | | | |
| saccharose) | | | | |
| Sweetener | | | 0.5 | 1 |
| (aspartame) | | | | |
| Flavouring | 0.2 | 0.3 | 0.4 | 0.5 |
| Melting salts | 0.5 | 1 | 1 | 1.5 |
| Citric acid | 0.2 | 0.2 | 0.25 | 0.15 |
| Carrageenans | 0.3 | 0.25 | 0.25 | 0.2 |
| ACH 121 | | | | |
| Xanthan | 0.2 | 0.2 | 0.2 | 0.1 |
| Rhodigel 200 | | | | |
| Water | 56.2 (of | 51.61 (of | 51.9 (of | 51.15 (of |
| | which | which 30% | which 30% | which 30% |
| | 30% water | water for | water for | water for |
| | for | cooking rice) | cooking rice) | cooking rice) |
| | cooking | | | |
| | rice) | | | |
| TOTAL | 100.00 | 100.00 | 100.00 | 100.00 |

Products A and B are produced according to the following method:
Preparation of a mixture consisting, in the proportions indicated in the table, of a protein source (milk protein concentrates), fat, sugar (saccharose), melting salts, carrageenans, xanthan gum, and rice previously cooked in the following conditions: Cooking of 10 g dry rice (for 100 g product) in 30 g water at 100° C. for 50 min in water at a ratio of I volume rice to 3 volumes water and water (sufficient for 100%); the quantity of rice is respectively 5 and 8%.
Heat treatment of the mixture with stirring (1000 rpm) at 145° C. for 3 s;
Cooling of the mixture to 80° C. and hot packaging in a flexible pouch containing 30 g product;
Cooling to 10° C.

In products C and D, the sugar was partially or totally replaced by a sweetener according to the proportions indicated, and the quantity of rice is respectively 10 and 12%.

Products C and D are produced according to the following method:
Mixture of the ingredients of the formulas according to the proportions indicated in table 1 with rice previously cooked under treatment conditions identical to products A and B, followed by heat treatment of the mixture with stirring (1000 rpm) at 100° C. for 2 min.
Cooking occurs in a cutter marketed by Stephan.
Cooling to 80° C.. and packaging at that temperature in a 10 g micropackets;
Cooling to 10° C.

The table below provides the characteristics of the composition of products A, B, C, and D.

| | A | B | C | D |
|---|---|---|---|---|
| Dry extract % | 40 | 43 | 45 | 45 |
| Fat/dry % | 40 | 45 | 35 | 50 |
| Fat: % | 16 | 19.35 | 15.75 | 22.5 |
| Protein % | 4.90 | 5.12 | 5.99 | 8.58 |
| Carbohydrates % | 16.59 | 16.45 | 20.58 | 11.48 |
| Lactose % | 3.77 | 0.25 | 7.68 | 1.88 |
| Calcium % | 0.14 | 0.07 | 0.18 | 0.22 |

Products A and B have a pH of 5.60, whilst products C and D have a pH of 5.45.

The products C and D obtained have a firmness measured by Stevens device of 150 g and a shelf life of 6 months at 10° C. They are intended for consumption by crunching.

Products A and B are for spreading. They have a Stevens value of 60 g and a shelf life of 6 months at room temperature.

### Example 2

A mixture consisting, in the proportions indicated in the table below, of a protein source (milk protein concentrates=MPC80+milk powder), fat (butter), sugar (saccharose), cereals (rice hydrated in the conditions of example 1), fruits (banana in the form of banana purée), melting salts, carrageenans, xanthan gum, and water (sufficient for 100%) is prepared.

The mixture is heat treated with stirring (1000 rpm) at 115° C. for 3 s;

The mixture is then cooled to 80° C. and packaged in flexible plastic pouches containing 25 g of the product.

The packaged product is then cooled to 10° C.

The table below provides the characteristics of the composition of the product.

| | |
|---|---|
| Dry extract | 40 |
| Fat/dry | 30 |
| Fat: | 12 |
| Protein | 8.00 |
| Calcium (%) | 0.60 |
| Carbohydrates | 16.50 |
| Lactose | 5.20 |

| Matter | % |
|---|---|
| Butter | 14.4 |
| Rice | 3 |
| Milk powder (0% MG) | 10.3 |
| MPC 80 | 5 |
| Sugar | 5 |
| Banana | 20 |
| Melting salts | 0.5 |
| Citric acid | 0.2 |
| Carrageenans | 0.5 |
| Xanthan | 0.1 |
| Water | 41.0 |
| Total | 100.0 |

The product has a firmness measured by Stevens device of 150 g and a shelf life of 6 months at 5-10° C.

1-14. (canceled)

15. A method for producing a sweet cheese product having a dry extract between 30 and 60% and comprising a sweet melted cheese base and a cereal mixed therein, the method comprising:
(a) heat treating a mixture at a temperature between 80 and 145° C. for a duration between 3 seconds and 6 minutes, wherein the mixture comprises:
(i) 3-40 weight % of a dairy protein;
(ii) 10-30 weight % of a fat;
(iii) 5-15 weight % of a sugar;
(iv) 0.1-3 weight % of an emulsifier, a texturing agent, or a combination thereof;
(v) 0.1-0.5 weight % of an acid;
(vi) water; and
(vii) 3-15 weight % of the cereal, wherein the cereal is in a flour form, a cooked and hydrated form, or a combination thereof;
(b) hot packaging the heat-treated mixture at a temperature between 70 and 100° C.; and
(c) cooling the hot-packaged mixture to a temperature between 5 and 15° C. thereby resulting in the sweet cheese product.

16. The method of claim 15, wherein the cereal is 5-10 weight % of the mixture and in flour form.

17. The method of claim 15, wherein the cooked and hydrated form of the cereal has a dry extract between 20 and 35%.

18. The method of claim 15, wherein the cereal is selected from the group consisting of rice, wheat, barley, maize, millet, sorghum, quinoa, and combinations thereof.

19. The method of claim 15, wherein the cereal has an amylose content that is less than or equal to 10%.

20. The method of claim 15, wherein the dairy protein is selected from the group consisting of whole milk powder, skim milk powder, caseins, caseinates, milk protein concentrates, serum protein concentrates, fresh or ripened cheeses, curds, yoghurts, fermented milks, and combinations thereof

21. The method of claim 15, wherein the fat is of animal origin, vegetable origin, or is a combination thereof.

22. The method of claim 15, wherein a portion of the sugar is replaced with a fruit.

23. The method of claim 22, wherein the fruit is selected from the group consisting of bananas, prunes, black currants, guava, chestnuts, figs, dates, and combinations thereof

24. A method for producing a sweet cheese product having a dry extract between 30 and 60% and comprising a sweet melted cheese base and a cereal mixed therein, the method comprising:
(a) heat treating a first mixture at a temperature between 80 and 145° C. for a duration between 3 seconds and 6 minutes to form the sweetened melted cheese base, wherein the first mixture comprises:
(i) 3-40 weight % of a dairy protein;
(ii) 10-30 weight % of a fat;
(iii) 0.1-3 weight % of an emulsifier, a texturing agent, or a combination thereof;
(iv) 5-15 weight % of a sugar;
(v) 0.1-0.5 weight % of an acid;
(vi) water; and
(vii) optionally, a first portion of the cereal, wherein the first portion of the cereal is 3-15 weight % of the first mixture and is in flour form;
thereby forming the sweetened melted cheese base;
(b) mixing the sweetened melted cheese base with a second portion of the cereal to form a second mixture, wherein the cereal is in a flour form, a cooked and hydrated form, or a combination thereof, and constitutes up to 60 weight % of the second mixture;
(c) heat treating the second mixture at a temperature between 100 and 145° C. for a duration between 3 seconds and 6 minutes;
(d) hot packaging of the heat-treated second mixture at a temperature between 70 and 100° C.; and
(e) cooling the hot-packaged mixture to a temperature between 5 and 15° C. thereby resulting in the sweet cheese product.

25. The method of claim 24, wherein the second portion of the cereal constitutes the entirety of the cereal in the sweet cheese product.

26. The method of claim 24, wherein the first and second portions of the cereal are in the sweet cheese product.

27. new The method of claim 24. wherein the first and second portions of the cereal are independently selected from the group consisting of rice, wheat, barley, maize millet, sorghum, quinoa, and combinations thereof.

28. The method of claim 24. wherein the cooked and hydrated form of the second portion of the cereal has a dry extract between 20 and 35%.

29. The method of claim 24, wherein the cereal has an amylose content that is less than or equal to 10%.

30. The method of claim 24, wherein the dairy protein is selected from the group consisting of whole milk powder, skim milk powder, caseins, caseinates, milk protein concentrates, serum protein concentrates, fresh or ripened cheeses, curds, yoghurts, fermented milks, and combinations thereof.

31. The method of claim 24, wherein the fat is of animal origin, vegetable origin, or is a combination thereof.

32. The method of claim 24, wherein a portion of the sugar is replaced with a fruit.

33. The method of claim 32, wherein the fruit is selected from the group consisting of bananas, prunes, black currants, guava, chestnuts, figs, dates, and combinations thereof.

34. A sweet cheese product having a dry extract between 30 and 60%, the sweet cheese product comprising:
(a) 3-40 weight % of a dairy protein;
(b) 10-30 weight % of a fat;
(c) 0.1-3 weight % of an emulsifier, a texturing agent, or a combination thereof;
(d) 3-15 weight % of a cereal;
(e) 5-15 weight % of a sugar;
(f) 0.1-0.5 weight % of an acid; and
(d) water:

35. The sweet cheese product of claim 35, wherein the cereal is selected from the group consisting of rice, wheat, barley, maize, millet, sorghum, quinoa, and combinations thereof;
the dairy protein is selected from the group consisting of whole milk powder, skim milk powder, caseins, caseinates, milk protein concentrates, serum protein concentrates, fresh or ripened cheeses, curds, yoghurts, fermented milks, and combinations thereof; and
the fat is of animal origin, vegetable origin, or is a combination thereof; and
a portion of the sugar is replaced with a fruit selected from the group consisting of bananas, prunes, black currants, guava, chestnuts, figs, dates, and combinations thereof.
